(19) United States
(12) Patent Application Publication
(10) Pub. No.: US 2007/0226504 A1
(43) Pub. Date: Sep. 27, 2007

(54) Signature match processing in a document registration system

(75) Inventors: Erik de la Iglesia, Mountain View, CA (US); Ratinder Paul Singh Ahuja, Saratoga, CA (US); William Deninger, San Jose, CA (US); Samuel King, Los Gatos, CA (US)

Correspondence Address: BLAKELY SOKOLOFF TAYLOR & ZAFMAN, 1279 OAKMEAD PARKWAY, SUNNYVALE, CA, 94085-4040, US

(73) Assignee: Reconnex Corporation

(21) Appl. No.: 11/389,630

(22) Filed: Mar. 24, 2006

(51) Int. Cl. H04L 9/00

(52) U.S. Cl. 713/176

(57) ABSTRACT

A document accessible over a network can be registered. A registered document, and the content contained therein, is not transmitted undetected over and off of the network. Signatures for registered documents are compared to signatures of objects being transmitted on the network to determine if the objects contain registered content.

### FIELD OF THE INVENTION

The present invention relates to computer networks, and in particular, to registering documents in a computer network.

### BACKGROUND

Computer networks and systems have become indispensable tools for modern business. Modern enterprises use such networks for communications and for storage. The information and data stored on the network of a business enterprise is often a highly valuable asset. Modern enterprises use numerous tools to keep outsiders, intruders, and unauthorized personnel from accessing valuable information stored on the network. These tools include firewalls, intrusion detection systems, and packet sniffer devices.

FIG. 1 illustrates a simple prior art configuration of a local area network (LAN) 100 connected to the Internet 102. Connected to the LAN 100 are various components, such as servers 104, clients 106, and switch 108. Numerous other networking components and computing devices are connectable to the LAN 100. The LAN 100 may be implemented using various wireline or wireless technologies, such as Ethernet and the 802.11 the IEEE family of wireless communication standards. LAN 100 could be connected to other LANs.

In this prior configuration, the LAN 100 is connected to the Internet 102 via a router 110. This router 110 may be used to implement a firewall. Firewalls are widely used to try to provide users of the LAN 100 with secure access to the Internet 102 as well as to provide separation of a public Web server (for example, one of the servers 104) from an internal network (for example, LAN 100). Data leaving the LAN 100 to the Internet 102 passes through the router 110. The router 110 simply forwards packets as is from the LAN 100 to the Internet 102.

However, once an intruder has gained access to sensitive content inside a LAN such as LAN 100, there presently is no network device that can prevent the electronic transmission of the content from the network to outside the network. Similarly, there is no network device that can analyse the data leaving the network to monitor for policy violations, and make it possible to track down information leeks. What is needed is a comprehensive system to capture, store, and analyse data communicated using the enterprise's network.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 is a block diagram illustrating a computer network connected to the Internet;

FIG. 2 is a block diagram illustrating one configuration of a capture system according to one embodiment of the present invention;

FIG. 3 is a block diagram illustrating the capture system according to one embodiment of the present invention;

FIG. 4 is a block diagram illustrating an object assembly module according to one embodiment of the present invention;

FIG. 5 is a block diagram illustrating an object store module according to one embodiment of the present invention;

FIG. 6 is a block diagram illustrating a document registration system according to one embodiment of the present invention;

FIG. 7 is a block diagram illustrating registration module according to one embodiment of the present invention; and

FIG. 8 illustrates an embodiment of the flow of the operation of a registration module;

FIG. 9 is a flow diagram illustrating an embodiment of a flow to generate signatures;

FIG. 10 is a flow diagram illustrating an embodiment of changing tokens into document signatures;

FIG. 11 illustrates an embodiment of a registration engine that generates signatures for documents;

FIG. 12 illustrates an exemplary embodiment of a system for the detection of registered content is performed on a distributed basis;

FIG. 13 illustrates an embodiment of a match agent to provide signature match processing;

FIG. 14 illustrates an embodiment of a capture/registration system to enforce registered policies with respect to registered documents;

FIG. 15 illustrates an embodiment of the capture and comparison flow; and

FIG. 16 shows an embodiment of a computing system (e.g., a computer).

### DETAILED DESCRIPTION

Although the present system will be discussed with reference to various illustrated examples, these examples should not be read to limit the broader spirit and scope of the present invention. Some portions of the detailed description that follows are presented in terms of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated.

It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Exemplary Networks

As described earlier, the router 110 of the prior art simply routes packets to and from a network and the Internet. While the router may log that a transaction has occurred (packets have been routed), it does not capture, analyze, or store the content contained in the packets.

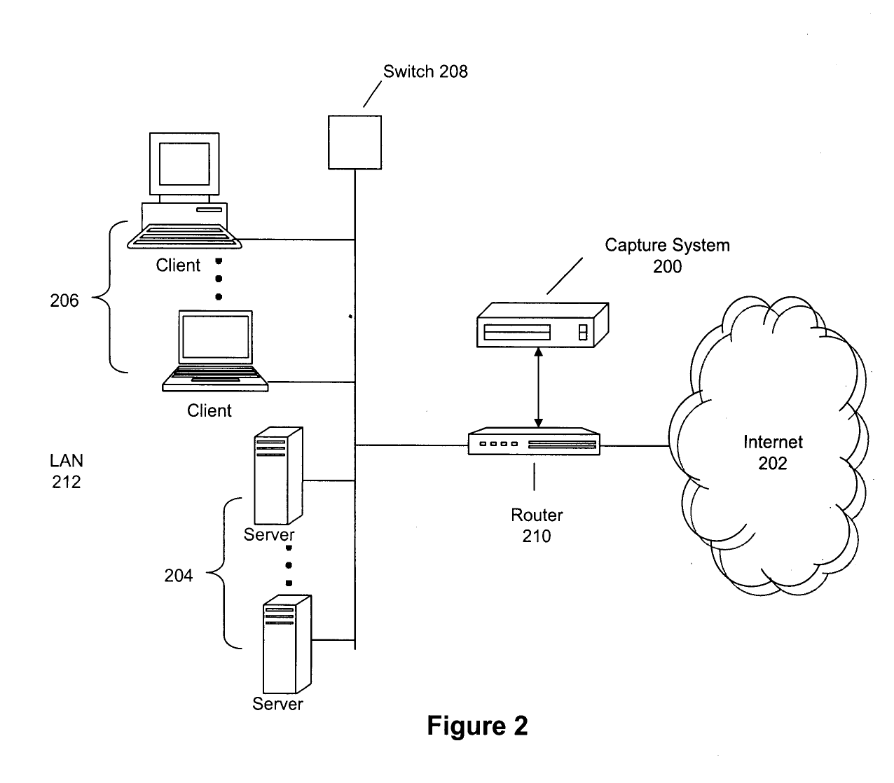

FIG. 2 illustrates an embodiment of a system utilizing a capture device. In FIG. 2, the router 210 is also connected to a capture system 200 in addition to the Internet 202 and LAN 212. Generally, the router 210 transmits the outgoing data stream to the Internet 202 and a copy of that stream to the capture system 200. The router 210 may also send incoming data to the capture system 200 and LAN 212.

However, other configurations are possible. For example, the capture system 200 may be configured sequentially in front of or behind the router 210. In systems where a router is not used, the capture system 200 is located between the LAN 212 and the Internet 202. In other words, if a router is not used the capture system 200 forwards packets to the Internet. In one embodiment, the capture system 200 has a user interface accessible from a LAN-attached device such as a client 206.

The capture system 200 intercepts data leaving a network such as LAN 212. In an embodiment, the capture system also intercepts data being communicated internal to a network such as LAN 212. The capture system 200 reconstructs the documents leaving the network 100 and stores them in a searchable fashion. The capture system 200 is then usable to search and sort through all documents that have left the network 100. There are many reasons such documents may be of interest, including network security reasons, intellectual property concerns, corporate governance regulations, and other corporate policy concerns. Exemplary documents include, but are not limited to, Microsoft Office documents, text files, images (such as JPEG, BMP, GIF, etc.), Portable Document Format (PDF) files, archive files (such as GZIP, ZIP, TAR, JAR, WAR, RAR, etc.), email messages, email attachments, audio files, video files, source code files, executable files, etc.

### Capture System

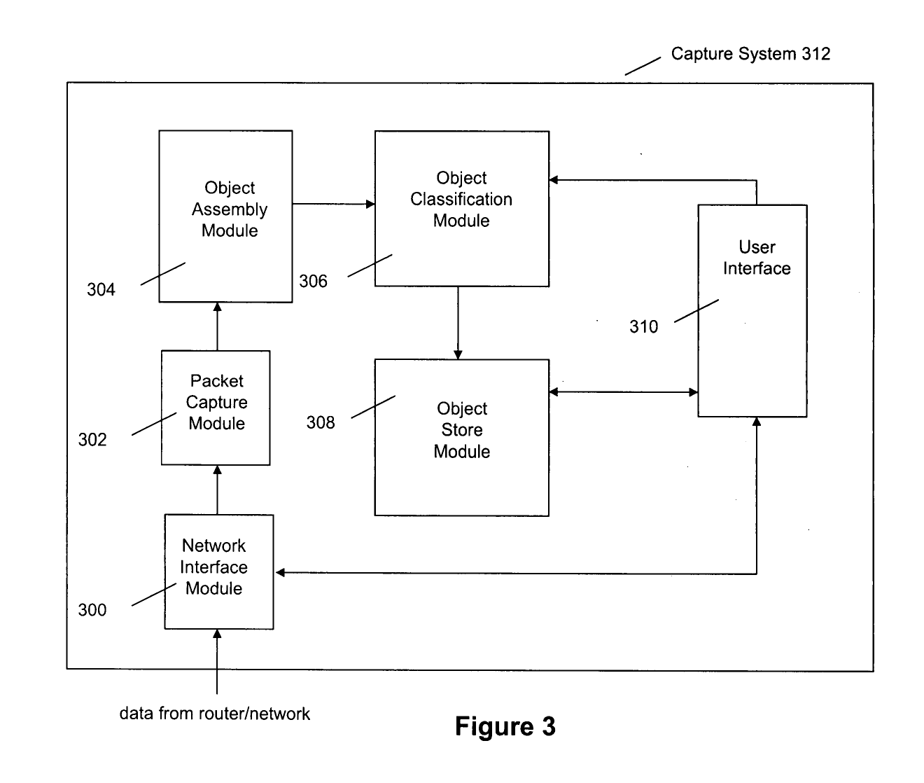

FIG. 3 shows an embodiment of a capture system in greater detail. A capture system (such as capture system 200 or 312) may also be referred to as a content analyzer, content or data analysis system, or other similar name. For simplicity, the capture system has been labeled as capture system 300. However, the discussion regarding capture system 300 is equally applicable to capture system 200. A network interface module 300 receives (captures) data from a network or router. Exemplary network interface modules 300 include network interface cards (NICs) (for example, Ethernet cards). More than one NIC may be present in the capture system 312.

Captured data is passed to a packet capture module 302 from the network interface module 300. The packet capture module 302 extracts packets from this data stream. Packet data is extracted from a packet by removing the headers and checksums from the packet. The packet capture module 302 may extract packets from multiple sources to multiple destinations for the data stream. One such case is asymmetric routing where packets from source A to destination B travel along one path but responses from destination B to source A travel along a different path. Each path may be a separate “source” for the packet capture module 302 to obtain packets.

An object assembly module 304 reconstructs the objects being transmitted from the packets extracted by the packet capture module 302. When a document is transmitted, such as in email attachment, it is broken down into packets according to various data transfer protocols such as Transmission Control Protocol/Internet Protocol (TCP/IP), UDP, HTTP, etc. The object assembly module 304 is able to reconstruct the original or reasonably equivalent document from the captured packets. For example, a PDF document would be broken down into packets before being transmitted from a network, these packets are reconfigurable to form the original (or reasonable equivalent) PDF. A complete data stream is obtained by reconstruction of multiple packets. The process by which a packet is created is beyond the scope of this application.

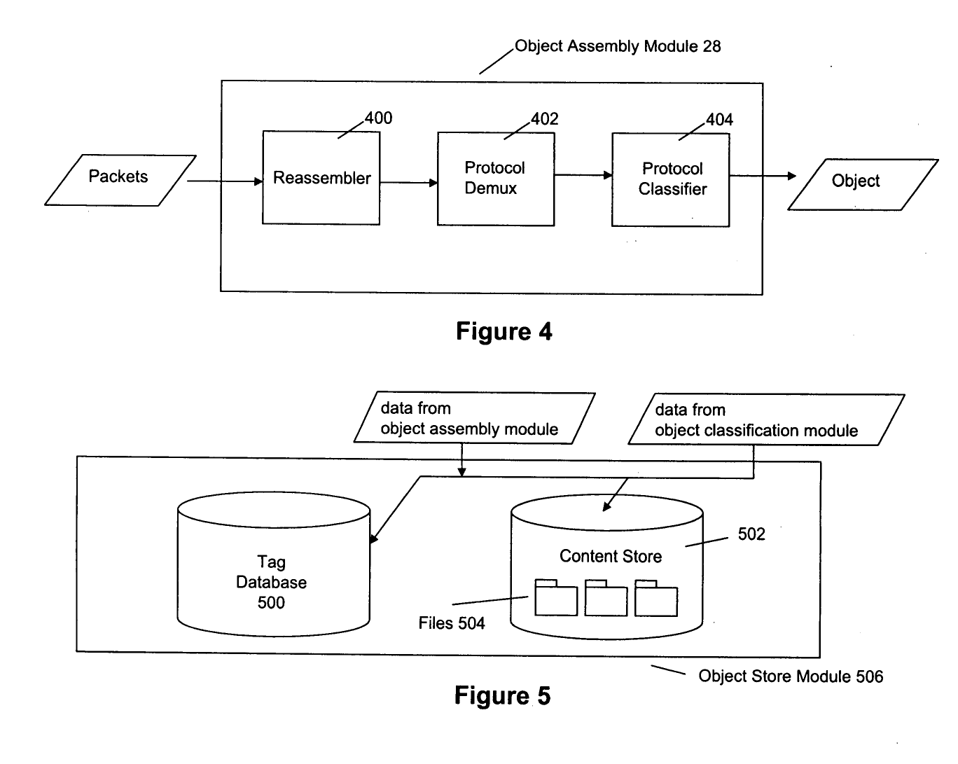

FIG. 4 illustrates an embodiment of an object assembly module. This object assembly module 406 includes a reassembler 400, protocol demultiplexer (demux) 402, and a protocol classifier 404. Packets entering the object assembly module 406 are provided to the reassembler 400. The reassembler 400 groups (assembles) the packets into at least one unique flow. An exemplary flow includes packets with identical source IP and destination IP addresses and/or identical TCP source and destination ports. In other words, the reassembler 400 organizes a packet stream by sender and recipient.

The reassembler 400 begins a new flow upon the observation of a starting packet. This starting packet is normally defined by the data transfer protocol being used. For TCP/IP, the starting packet is generally referred to as the “SYN” packet. The flow terminates upon observing a finishing packet (for example, a “Reset” or “FIN” packet in TCP/IP). If the finishing packet is observed by the reassembler 400 within a pre-determined time constraint, the flow terminates via a timeout mechanism. A TCP flow contains an ordered sequence of packets that may be assembled into a contiguous data stream by the reassembler 400. Thus, a flow is an ordered data stream of a single communication between a source and a destination.

The flow assembled by the reassembler 400 is provided to a protocol demultiplexer (demux) 402. In an embodiment, the protocol demux 402 sorts assembled flows using ports, such as TCP and/or UDP ports, by performing a speculative classification of the flow contents based on the association of well-known port numbers with specified protocols. For example, Web Hyper Text Transfer Protocol (HTTP) packets (such as, Web traffic packets) are typically associated with TCP port 80, File Transfer Protocol (FTP) packets with TCP port 20, Kerberos authentication packets with TCP port 88, etc. Thus, the protocol demux 402 separates the different protocols that exist in a flow.

A protocol classifier 404 may further sort the flows in addition to the sorting done by the protocol demux 402. The protocol classifier 404 (operating either in parallel or in sequence to the protocol demux 402) applies signature filters to a flow to attempt to identify the protocol based solely on the transported data. Furthermore, the protocol classifier 404 may override the classification assigned by the protocol demux 402. The protocol classifier 404 uses a protocol's signature(s) (such as, the characteristic data sequences of a defined protocol) to verify the speculative classification performed by the protocol demux 402. For example, if an individual or program attempted to masquerade an illicit communication (such as file sharing) using an apparently benign port (for example, TCP port 80), the protocol classifier 404 would use the HTTP protocol signature(s) to verify the speculative classification performed by protocol demux 402.

An object assembly module, such as object assembly modules 304 and 406 outputs each flow, organized by protocol, which represent the underlying objects being transmitted. These objects are passed to the object classification module 306 (also referred to as the “content classifier”) for classification based on content. A classified flow may still contain multiple content objects depending on the protocol used. For example, a single flow using HTTP may contain over 100 objects of any number of content types. To deconstruct the flow, each object contained in the flow is individually extracted and decoded, if necessary, by the object classification module 306.

The object classification module 306 uses the inherent properties and/or signatures of various documents to determine the content type of each object. For example, a Word document has a signature that is distinct from a PowerPoint document or an email. The object classification module 306 extracts each object and sorts them according to content type. This classification prevents the transfer of a document whose file extension or other property has been altered. For example, a Word document may have its extension changed from .doc to .dock but the properties and/or signatures of that Word document remain the same and detectable by the object classification module 306. In other words, the object classification module 306 does more than simple extension filtering.

The object classification module 306 may also determine whether each object should be stored or discarded. This determination is based on definable capture rules used by the object classification module 306. For example, a capture rule may indicate that all Web traffic is to be discarded. Another capture rule could indicate that all PowerPoint documents should be stored except for ones originating from the CEO's IP address. Such capture rules may be implemented as regular expressions or by other similar means.

The capture rules may be authored by users of a capture system. The capture system may also be made accessible to any network-connected machine through the network interface module 300 and/or user interface 310. In one embodiment, the user interface 310 is a graphical user interface providing the user with friendly access to the various features of the capture system 312. For example, the user interface 310 may provide a capture rule authoring tool that allows any capture rule desired to be written. These rules are then applied by the object classification module 306 when determining whether an object should be stored. The user interface 310 may also provide pre-configured capture rules that the user selects from along with an explanation of the operation of such standard included capture rules. Generally, by default, the capture rule(s) implemented by the object classification module 306 captures all objects leaving the network that the capture system is associated with.

If the capture of an object is mandated by one or more capture rules, the object classification module 306 may determine where in the object store module 308 the captured object should be stored. FIG. 5 illustrates an embodiment of an object store module. Within the content store 502 are files 504 grouped up by content type. Thus, for example, if an object classification module (such as object classification module 306) determines that an object is a Word document that should be stored, it can store it in the file 504 reserved for Word documents. The object store module 506 may be internal to a capture system or external (entirely or in part) using, for example, some network storage technique such as network attached storage (NAS), and storage area network (SAN), or other database.

In an embodiment, the content store 502 is a canonical storage location that is simply a place to deposit the captured objects. The indexing of the objects stored in the content store 502 is accomplished using a tag database 500. The tag database 500 is a database data structure in which each record is a “tag” that indexes an object in the content store 502 and contains relevant information about the stored object. An example of a tag record in the tag database 500 that indexes an object stored in the content store 502 is set forth in Table 1:

TABLE 1

| Field Name | Definition (Relevant Information) |
|---|---|
| MAC Address | NIC MAC address |
| Source IP | Source IP Address of object |
| Destination IP | Destination IP Address of object |
| Source Port | Source port number of object |
| Destination Port | Destination port number of the object |
| Protocol | Protocol that carried the object |
| Instance | Canonical count identifying object within a |
| | protocol capable of carrying multiple data |
| | within a single TCP/IP connection |
| Content | Content type of the object |
| Encoding | Encoding used by the protocol carrying object |
| Size | Size of object |
| Timestamp | Time that the object was captured |
| Owner | User requesting the capture of object |
| | (possibly rule author) |
| Configuration | Capture rule directing the capture of object |
| Signature | Hash signature of object |
| Tag Signature | Hash signature of all preceding tag fields |

There are various other possible tag fields and some tag fields listed in Table 1 may not be used. In an embodiment, the tag database 500 is not implemented as a database and another data structure is used.

The mapping of tags to objects may be obtained by using unique combinations of tag fields to construct an object's name. For example, one such possible combination is an ordered list of the source IP, destination IP, source port, destination port, instance and timestamp. Many other such combinations including both shorter and longer names are possible. A tag may contain a pointer to the storage location where the indexed object is stored.

The objects and tags stored in the object store module 308 may be interactively queried by a user via the user interface 310. In one embodiment, the user interface interacts with a web server (not shown) to provide the user with Web-based access to the capture system 312. The objects in the object store module 308 are searchable for specific textual or graphical content using exact matches, patterns, keywords, and/or various other attributes.

For example, the user interface 310 may provide a query-authoring tool (not shown) to enable users to create complex searches of the object store module 308. These search queries are provided to a data mining engine (not shown) that parses the queries the object store module. For example, tag database 500 may be scanned and the associated object retrieved from the content store 502. Objects that matched the specific search criteria in the user-authored query are counted and/or displayed to the user by the user interface 310.

Searches may be scheduled to occur at specific times or at regular intervals. The user interface 310 may provide access to a scheduler (not shown) that periodically executes specific queries. Reports containing the results of these searches are made available to the user at runtime or at a later time such as generating an alarm in the form of an e-mail message, page, system log, and/or other notification format.

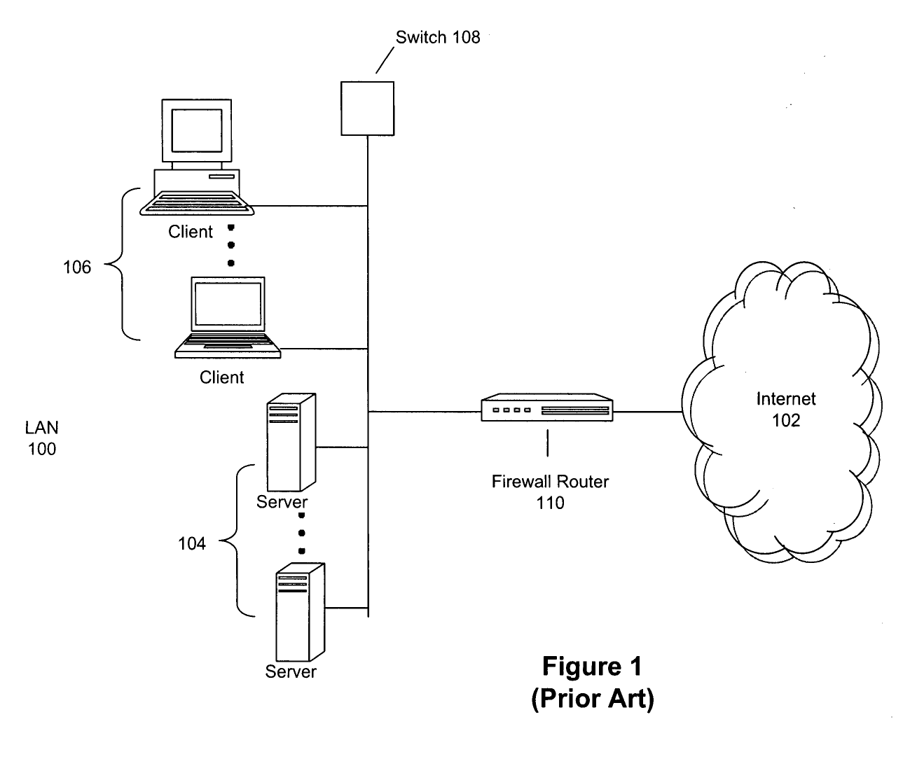

Generally, a capture system has been described above as a stand-alone device. However, capture systems may be implemented on any appliance capable of capturing and analyzing data from a network. For example, the capture system 310 described above could be implemented on one or more of the servers or clients shown in FIG. 1. Additionally, a capture system may interface with a network in any number of ways including wirelessly.

### Document Registration

The capture system described above implements a document registration scheme. A user registers a document with a capture system, the system then alerts the user if all or part of the content in the registered document is attempting to, or leaving, the network. Thus, un-authorized documents of various formats (e.g., Microsoft Word, Excel, PowerPoint, source code of any kind, text are prevented) are prevented from leaving an enterprise. There are great benefits to any enterprise that keeps its intellectual property, and other critical, confidential, or otherwise private and proprietary content from being mishandled. Sensitive documents are typically registered with the capture system 200, although registration may be implemented using a separate device.

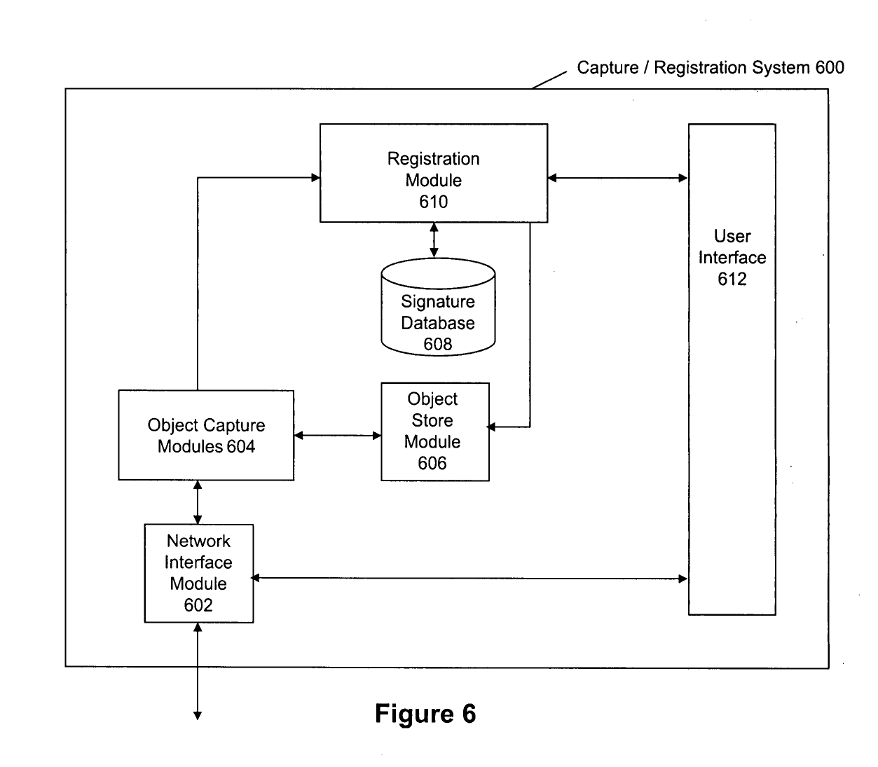

FIG. 6 illustrates an embodiment of a capture/registration system. The capture/registration system 600 has components which are used in a similar number similar or identical to the capture system 300 shown in FIG. 3, including the network interface module 602, the object store module 606, user interface 612, and object capture modules 604 (the packet capture 302, object assembly 304, and object classification 306 modules of FIG. 3).

The capture/registration system 600 includes a registration module 610 interacting with a signature storage 608 (such as a database) to help facilitate a registration scheme. There are numerous ways to register documents. For example, a document may be electronically mailed (e-mailed), uploaded to the registration system 600 (for example through the network interface module 702 or through removable media), the registration system 600 scanning a file server (registration server) for documents to be registered, etc. The registration process may be integrated with an enterprise's document management systems. Document registration may also be automated and transparent based on registration rules, such as “register all documents,” “register all documents by specific author or IP address,” etc.

After being received, classified, etc., a document to be registered is passed to the registration module 610. The registration module 610 calculates a signature or a set of signatures of the document. A signature associated with a document may be calculated in various ways. An exemplary signature consists of hashes over various portions of the document, such as selected or all pages, paragraphs, tables and sentences. Other possible signatures include, but are not limited to, hashes over embedded content, indices, headers, footers, formatting information, or font utilization. A signature may also include computations and meta-data other than hashes, such as word Relative Frequency Methods (RFM)-Statistical, Karp-Rabin Greedy-String-Tiling-Transposition, vector space models, diagrammatic structure analysis, etc.

The signature or set of signatures associated on a document is stored in the signature storage 608. The signature storage 608 may be implemented as a database or other appropriate data structure as described earlier. In an embodiment, the signature storage 608 is external to the capture system 600.

Registered documents are stored as objects in the object store module 606 according to the rules set for the system. In an embodiment, only documents are stored in the content store 606 of the object system network. These documents have no associated tag since many tag fields do not apply to registered documents.

As set forth above, the object capture modules 602 extract objects leaving the network and store various objects based on capture rules. In an embodiment, all extracted objects (whether subject to a capture rule or not) are also passed to the registration module for a determination whether each object is, or includes part of, a registered document.

The registration module 610 calculates the set of one or more signatures of an object received from the object capture modules 604 in the same manner as the calculation of the set of one or more signatures of a document received from the user interface 612 to be registered. This set of signatures is then compared against all signatures in the signature database 608. However, parts of the signature database may be excluded from a search to decrease the amount comparisons to be performed.

A possible unauthorized transmission is detectable if any one or more signatures in the set of signatures of an extracted object matches one or more signatures in the signature database 608 associated with a registered document. Detection tolerances are usually configurable. For example, the system may be configured so that at least two signatures must match before a document is deemed unauthorized. Additionally, special rules may be implemented that make a transmission authorized (for example, if the source address is authorized to transmit any documents off the network).

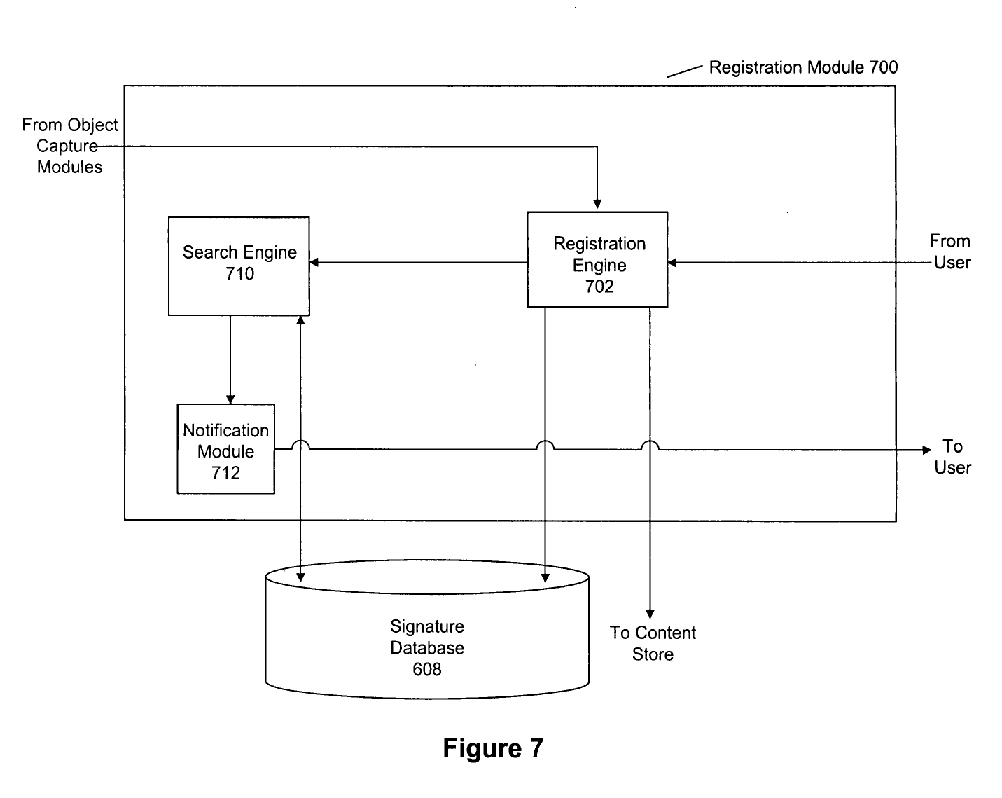

An embodiment of a registration module is illustrated in FIG. 7. As discussed above, a user may select a document to be registered. The registration engine 702 generates signatures for the document and forwards the document to content storage and the generated signatures to the signature database 608. Generated signatures are associated with a document, for example, by including a pointer to the document or to some attribute to identify the document.

The registration engine calculates signatures for a captured object and forwards them to the search engine 710. The search engine 710 queries the signature database 608 to compare the signatures of a captured object to the document signatures stored in the signature database 608. Assuming for the purposes of illustration, that the captured object is a Word document that contains a pasted paragraph from registered PowerPoint document, at least one signature of registered PowerPoint signatures will match a signature of the captured Word document. This type of event is referred to as the detection of an unauthorized transfer, a registered content transfer, or other similarly descriptive term.

When a registered content transfer is detected, the transmission may be halted or allowed with or without warning to the sender. In the event of a detected registered content transfer, the search engine 710 may activate the notification module 712, which sends an alert to the registered document owner. The notification module 712 may send different alerts (including different user options) based on the user preference associated with the registration and the capabilities of the registration system.

An alert indicates that an attempt (successful or unsuccessful) to transfer a registered content off the network has been made. Additionally, an alert may provide information regarding the transfer, such as source IP, destination IP, any other information contained in the tag of the captured object, or some other derived information, such as the name of the person who transferred the document off the network. Alerts are provided to one or more users via e-mail, instant message (IM), page, etc. based on the registration parameters. For example, if the registration parameters dictate that an alert is only to be sent to the entity or user who requested registration of a document then no other entity or user will receive an alert.

If the delivery of a captured object is halted (the transfer is not completed), the user who registered the document may need to provide consent to allow the transfer to complete. Accordingly, an alert may contain some or all of the information described above and additionally contain a selection mechanism, such as one or two buttons—to allow the user to indicate whether the transfer of the captured object is eligible for completing. If the user elects to allow the transfer, (for example, because he is aware that someone is emailing a part of a registered document (such as a boss asking his secretary to send an email), the transfer is executed and the captured object is allowed to leave the network.

If the user disallows the transfer, the captured object is not allowed off of the network and delivery is permanently halted. Several halting techniques may be used such as having the registration system proxy the connection between the network and the outside, using a black hole technique (discarding the packets without notice if the transfer is disallowed), a poison technique (inserting additional packets onto the network to cause the sender's connection to fail), etc.

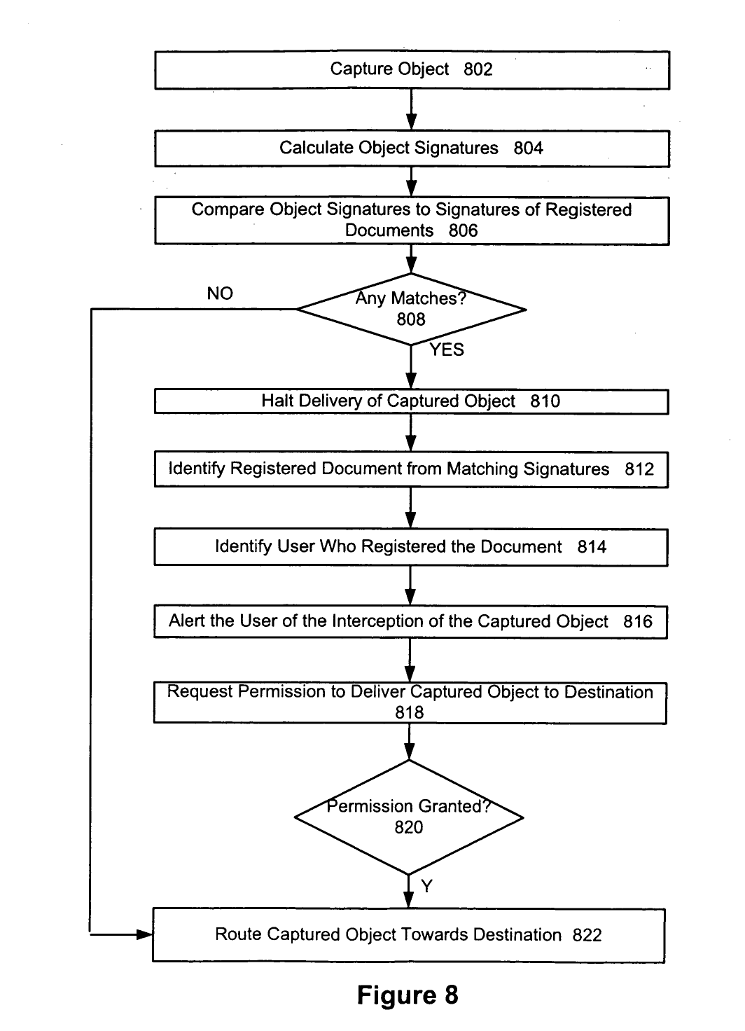

FIG. 8 illustrates an embodiment of the flow of the operation of a registration module. An object is captured at 802. This object was sent from an internal network source and designated for delivery inside and/or outside of the network.

A signature or signatures are generated for this captured object at 804. This signature or signatures are generated in a manner as described earlier. The signatures of the captured document are compared to the signatures of registered documents at 806. For example, the search engine 710 queries the signature database which houses the signatures for registers documents and compares these registered document signatures to the signatures generated for the captured document.

If there are no matches at 808, then the captured object is routed toward its destination at 822. This routing is allowed to take place because the captured object has been deemed to not contain any material that has been registered with the system as warranting protection. If there is a match at 808, further processing is needed.

In an embodiment, the delivery of the captured object is halted at 810. Halting delivery prevents any questionable objects from leaving the network. Regardless if the delivery is halted or not, the registered document that has signatures that match the captured object's signatures is identified at 812. Furthermore, the identity of the user or entity that registered the document is ascertained at 814.

The user or entity of the matching registered document is alerted to this attempt to transmit registered material at 816. This alert may be sent to the registered user or entity in real-time, be a part of a log to be checked, or be sent to the registered user or entity at a later point in time. In an embodiment, an alert is sent to the party attempting to transmit the captured object that the captured object contains registered information.

A request to allow delivery of the captured object may be made to the registered user or entity at 818. As described earlier, there are situations in which a captured object that contains registered material should be allowed to be delivered. If the permission is granted at 820, the captured object is routed toward its destination at 822. If permission is not granted, the captured object is not allowed to leave the network.

### Signature Generation

There are various methods and processes by which the signatures are generated, for example, in the registration engine 702 in FIG. 7.

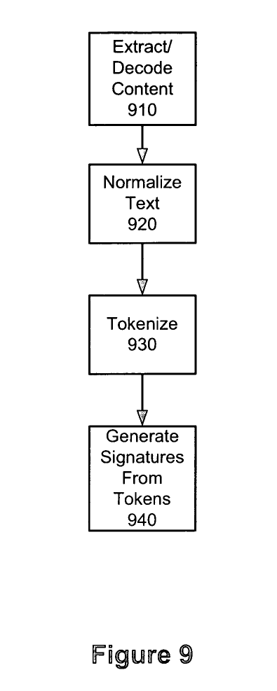

One embodiment of a flow to generate signatures is illustrated in FIG. 9. The content of a document (register or intercepted) is extracted and/or decoded depending on the type of content contained in the document at 910. The content is extracted by removing the “encapsulation” of the document. For example, if the document is a Microsoft Word file, then the textual content of the file is extracted and the specific MS Word formatting is removed. If the document is a PDF file, the content has to be additionally decoded, as the PDF format utilizes a content encoding scheme.

To perform the text extraction/decoding at 910, the content type of the document is detected (for example, from the tag associated with the document). Then, the proper extractor/decoder is selected based on the content type. An extractor and/or decoder used for each content type extracts and/or decodes the content of the document as required. Several off the shelf products are available, such as the PDFtoText software, may be used for this purpose. In one embodiment, a unique extractor and/or decoder is used for each possible content type. In another embodiment, a more generic extractor and/or decoder is utilized.

The text content resulting from the extraction/decoding is normalized at 920. Normalization includes removing excess delimiters from the text. Delimiters are characters used to separate text, such as a space, a comma, a semicolon, a slash, tab, etc. For example, the extracted text version of an Microsoft Excel spreadsheet may have two slashes between all table entries and the normalized text may have only one slash between each table entry or it may have one space between each table entry and one space between the words and numbers of the text extracted from each entry.

Normalization may also include delimiting items in an intelligent manner. For example, while credit card numbers generally have spaces between them they are a single item. Similarly, e-mail addresses that look like several words are a single item in the normalized text content. Strings and text identified as irrelevant can be discarded as part of the normalization procedure.

In one embodiment, such evaluations are made by comparison to a pattern. For example, a pattern for a social security number may be XXX-XX-XXXX, XXXXXXXX, or XXX XX XXXX, where each X is a digit from 0-9. An exemplary pattern for an email address is word@word.three-letter-word. Similarly, irrelevant (non-unique) stings, such as copyright notices, can have associated patterns.

The pattern comparison is prioritized in one embodiment. For example, if an email address is considered more restrictive than a proper name and a particular string could be either an email address or a proper name, the string is first tested as a possible email address. A string matching the email pattern is classified as an email address and normalized as such. If, however, it is determined that the string is not an email address, then the string is tested against the proper name pattern (for example, a combination of known names). If this produces a match, then the string is normalized as a proper name. Otherwise the string is normalized as any other normal word.

By comparing the normalization patterns against the string to be normalized in sequence, an implicit pattern hierarchy is established. In one embodiment, the hierarchy is organized such that the more restrictive, or unique, a pattern is, the higher its priority. In other words, the more restrictive the pattern, the earlier it is compared with the string. Any number of normalization patterns useable and the list of patterns may be configurable to account for the needs of a particular enterprise.

Normalization may also include discarding text that is irrelevant for signature generation purposes. For example, text that is known not to be unique to the document may be considered irrelevant. The copyright notice that begins a source code document, such as a C++ source file, is generally not relevant for signature generation, since every source code document of the enterprise has the identical textual notice and would be ignored. Irrelevant text is identified based on matching an enumerated list of known irrelevant text or by keeping count of certain text and thus identifying frequently reoccurring strings (such as strings occurring above a certain threshold rate) as non-unique and thus irrelevant. Other processes to identify irrelevant text include, but are not limited to, identification through pattern matching, identification by matching against a template, and heuristic methods requiring parsing of examples of other documents of the same type.

The delimitated text items of the normalized text content are tokenized, and, converted into a list of tokens at 930. In one embodiment, tokenizing involves only listing the delimited items. In another embodiment, each item is converted to a token of fixed size. Text items may be hashed into a fixed or configurable hash site such as binary number (for example, an 8-bit token). An exemplary hash function that may be used for tokenizing is MD5.

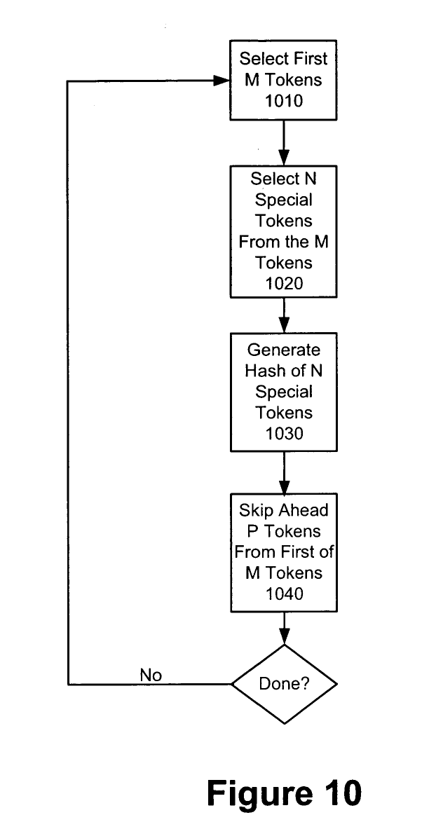

The document signatures are generated from the list of tokens at 940. An exemplary embodiment of a flow for changing tokens into document signatures is described with reference to FIG. 10. The first M tokens from a list of tokens generated from a document are selected at 1010, where M is an appropriate positive integer value. For example, if M is 10, then the first ten tokens from a list are selected.

Of the selected M tokens, N special tokens are selected at 1020, N also being an appropriate positive integer and is less than, or equal to, M. The N special tokens may be selected at random, in part based on size, and/or in part on obscurity. Tokens that occur less frequently are more obscure and thus more likely to be selected as a special token. A token dictionary may be provided to log the frequency of tokens.

The special tokens may also be selected based on the type of the token as defined by the normalization pattern matched by the source string. As set forth above, during the normalization process, some strings are identified as higher priority text (such as email addresses, credit card numbers, etc.) the tokenization of which results in higher priority tokens. Thus, the selection of the N special tokens may take the source string into account.

Tokens may also have an associated priority value that may be used in selecting the special tokens. The priority value can be based on the priority of the normalization pattern matched by the token (for example, social security number, credit card number, email address, etc.) or based on additional signs of uniqueness, such as the frequency of capitalized letters, and the inclusion of special rare characters (for example, “ˆ”, “*”, “@”, etc.)

A hash signature of the N special tokens is calculated, resulting in one of the document signatures at 1320. The hash is calculable in a number or ways. Special tokens may be hashed individually, or in groups, and the resultant hashes concatenated to form a signature, concatenated prior to the calculation, or hashed without concatenation at all. Any appropriate hash function and/or any combination of these hashing techniques may be utilized.

In one embodiment, before the next M tokens are selected, P tokens of the list of tokens are skipped from the first token of the M tokens. However, if P is zero, the next M tokens would be identical to the current M tokens, and therefore zero is not an allowed value for P. If P is less than M, then the next set of M tokens will overlap with the current set of M tokens. If P is equal to M, then the first token of the next M tokens will immediately follow the last token of the current M tokens. If P is greater than M, then some tokens are skipped between the next and the current M tokens.

A determination is made as to whether all signatures have been generated at 1040. This is be done by observing if there are less than M tokens remaining on the list, hence, the next M tokens cannot be selected. If all signatures for the document have been generated, then the process terminates. However, if more signatures are to be generated for the document the next M tokens are selected by reverting to selecting tokens at 1010.

There are numerous other ways to perform each of the proceedings of FIGS. 9 and 10. Some blocks are skipped entirely in some embodiments. For example, block 930 in FIG. 9 may be skipped and the signatures generated directly from the normalized text. Regarding FIG. 10, various values may be used for M, N, and P, with each combination generating a different number of signatures. The specific configuration of M, N, and P thus depends on the needs of the enterprise and the volume and content of captured and registered documents. In an embodiment, M ranges between 8-20, N between 8-10, and P between 4-40.

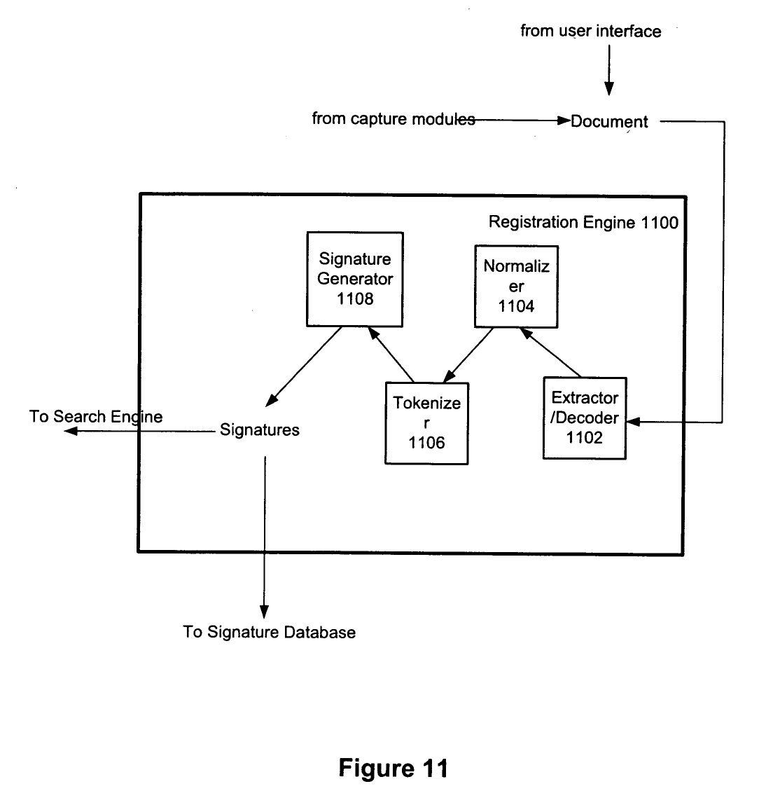

An embodiment, of a registration engine that generates signatures for documents is illustrated in FIG. 11. The registration engine 1100 accepts documents, and generates signatures over these documents. The document may be one registered via the user interface, or one captured by the capture modules, as described earlier.

The registration engine 1100 includes an extractor/decoder 1102 to perform the functionality described with reference to block 910 of FIG. 9. The registration engine also includes a normalizer 1104 to perform the functionality described with reference to block 920 of FIG. 9. A tokenizer 1106 performs the functionality described with reference to 930 of FIG. 9. A signature generator 1108 performs the functionality described with reference to block 940 of FIG. 9. The signature 1100 generator may implement the process described with reference to FIG. 10.

### Distributed Signature Matching

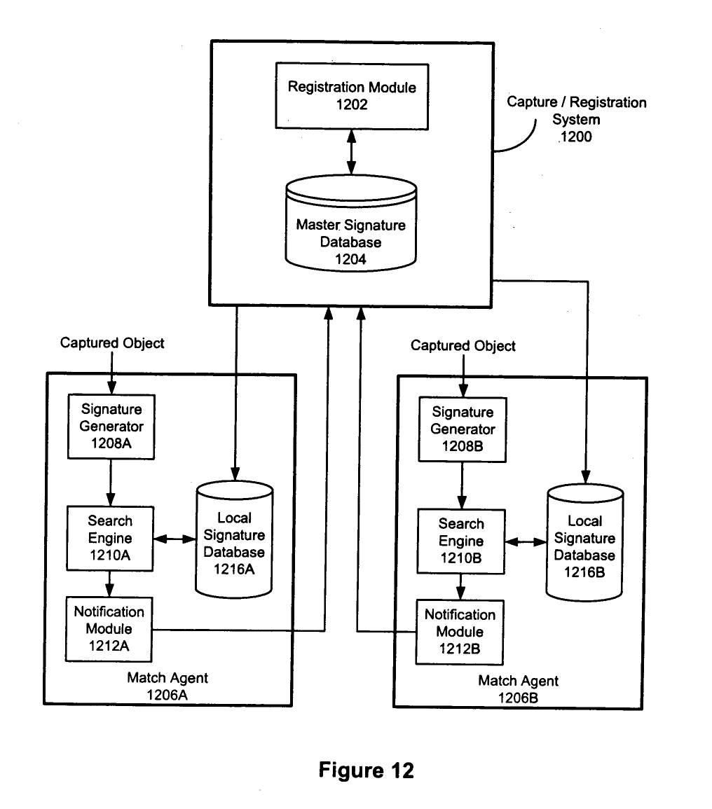

FIG. 12 illustrates an exemplary embodiment of a system for the detection of registered content is performed on a distributed basis. The capture/registration system 1200 includes a registration module and a master signature database 1204. These components are similar or even identical to the capture/registration system 600 described earlier, registration module 610, and signature database 608 as described with reference to FIGS. 6 and 7. Document registration is carried out by the capture/registration system 1200 as described above for other embodiments of the capture/registration system.

Detection of registered content, however, is performed in a distributed manner by match agents 1206A,B in an embodiment. The capture/registration system 1200 is also referred to as “manager agent”. A match agent 1206A,B is implemented on a capture device, such as described earlier, that captures objects being transmitted on a network. A match agent 1206A,b may include object capture modules and network interface modules (not shown) to aid in capturing objects. Generally, a match agent 1206A,B does not register documents (this is done centrally by the capture/registration system 1200), but matches registered signatures against objects captured over a portion of a network monitored by the device that includes the match agent 1206A,B. For example, a network may have two or more capture devices each with its own match agent. In this manner, signature matching is distributed while document registration is centralized.

For simplicity, only two match agents 1206A,B are shown in FIG. 12. Of course, more match agents may be utilized. Match agents are assignable to network segments, office sites, or any other logical organization. Each match agent 1206A,B includes a signature generator 1208A,B; search engine 1210A,B; and a local signature database 1216A,B.

A signature generator 1208A,B generates the one or more signatures of an captured object, similar to the function of the registration engine 702 described above with reference to FIG. 7.

A search engine 1210A, B (similar or identical to search engine 710 in FIG. 7) compares the signature(s) of the captured object from the signature generator 1210A,B with signatures stored in local signature database 1216A,B. If a match is found and therefore registered content is detected, the search engine 1210A,B informs the notification module 1212A,B, which may communicate the presence of registered content to the capture/registration system 1200. The notification module 1212A,B may also record the match in a log file or database (not shown).

One challenge that arises in such a distributed signature matching architecture, is keeping the local signature databases 1216A,B up-to-date and synchronized with the master signature database 1204. For example, when a user registers a document with the capture/registration system 1200, new signatures for that document should be provided to the local signature databases 1216A,B. Similarly, if a signature is deleted or a document is de-registered from the master signature database 1204, local signature database 1216A,B updates should be performed.

### Local Signature Database Updates

The master database contains records including a signature and document identifier for register documents as described in detail earlier. The document identifier can be any identifier uniquely associated with an object or a pointer to stored object and identifies the registered document associated with the signature. Since a single registered document may have multiple signatures and various documents may result in the same signature, neither the signature nor the document identifier need to be unique for each record in the signature databases. However, the combination of a signature and a document identifier is unique as there is no need to store the same signature for the same document twice. Thus, the combination of signature and document identifier is the primary key of the master signature database 1204 and is searchable using this primary key.

A portion of an exemplary master signature database 1204 is now provided as Table 2:

TABLE 2

| Signatures | Document ID |
|---|---|
| Signature A | Document X |
| Signature B | Document X |
| Signature C | Document X |
| Signature D | Document Y |
| Signature A | Document Y |
| Signature E | Document Y |
| Signature C | Document Z |
| Signature F | Document Z |

The master signature database 1204 may also have other fields associated with each record in the table (signature, document combination) such as the relative or absolute position of the signature within the document, the relative uniqueness of the signature (as compared to other signatures in that document or among all documents), etc. In the example of Table 2, Signature A appears in multiple documents (Document X and Document Y), and Document X has multiple signatures (Signatures A, B, and C), the combination (concatenation) of Signature and Document ID is unique and can be used as the primary key of the master signature database 1204. For example, the combination “Signature A:Document X” is unique to the table.

The local signature databases 1216A,B utilize the same or similar structure as master signature database 1204. However, in an embodiment, to speed matching operations of the search engines 1210A,B, each signature is only stored once in the local signature databases 1216A,B. An example of a local signature database is of this type is depicted in Table 3:

TABLE 3

| Signatures | Document ID |
|---|---|
| Signature A | Document X |
| Signature B | Document X |
| Signature C | Document X |
| Signature D | Document Y |
| Signature E | Document Y |
| Signature F | Document Z |

Each signature is unique (none are repeated). Accordingly, for a local signature database 1216A,B, the signature alone is used as the primary key. Thus, the search engine 1210A,B of a match agent 1206A,B may use the signatures of the captured object directly to search for matches.

If a signature could be associated with more than one document, it does not matter which of the documents that a signature is associated with. In other words, Signature C could be associated by either Document X or Document Z in Table 3.

When the search engine 1210A,B matches a signature in the local signature database 1216A,B to a captured object, the notification module 1212A,B provides the document identifier associated with the signature in the local signature database 1216A,B to the capture/registration system 1200. The capture/registration system 1200 is then able to identify all other registered documents that include the signature matched by the match agent 1206A,B. For example, if the master signature database 1204 is as shown in Table 2 and the match agent 1206A,B has the local signature database 1216A,B as shown in Table 3, and Signature A is matched to a captured object by the match agent 1206A,B, Signature A and/or the associated Object X is provided to the capture/registration system 1200. The capture/registration system 1200 may look up Signature A in the master signature database 1200 as shown in Table 2 to find that Signature A is also found in Document Y.

The master signature database 1204 may change due to a new document being registered, a document becoming de-registered, a single signature being deleted without de-registering of any documents, etc. Such changes require an update to at least some of the local signature databases 1216A,B. This update may be performed in real-time as the change is made in the master signature database 1204, periodically, or on command.

Updates may occur via update patches (small changes) or re-writing the entire contents of a database. An update patch inserted into a local signature database contains a list of signatures and associated document identifiers. Generally, each signature found in the local signature database is overwritten (if they are found) with the new document identifier. If not found, the record of the signature and the object identifier is added. Records are removable by overwriting the associated document identifier with a pre-determined value, such as zero, or other common deletion techniques.

Update patches are temporally relevant. In other words, the series of update patches produced by the capture/registration system 1200 are inserted in a specific order by a match agent 1206A,B. In this manner, the update patches are queued individually for each separate match agent 1206A,B. Thus, if one match agent 1206A,B goes offline, the other online match agents 1206A,B are still be updated. When the match agent 1206A,B is repaired and online, it installs the update patches it missed in sequence. Of course, the capture/registration system 1200 may generate a master patch to update the repaired match agent with a single update patch.

In an embodiment, the master patch required to update a match agent 1206A,B is generated by temporarily halting the insertion of new document signatures and generating a complete listing of all unique signatures in the signature database. In this manner, signature insertion is allowed to resume as soon as this patch has been queued for transport to match agent 1206A,B even if such transport has not been completed. Subsequent update patches are temporally relevant with respect to this master patch and are queued for subsequent application.

### Signature Match Processing

Objects captured by a match agent 1206A,B are analyzed to determine if they contain signatures from any documents registered in the master signature database 1204. Signatures present in master signature database 1204 will, by the process of signature distribution, be present in local signature database 1216A,B allowing for faster processing. Objects found to contain text matching any signature in the local signature database 1216A,B may generate a match notification maintained locally on match agent 1206A,B and transported to the registration module 1202 for centralized reporting. Matching a signature in a local signature database 1216A,B is a necessary, but generally insufficient, condition for generating such a notification.

One embodiment of signature checking by a match agent 1206A,B performed by a search engine 1210A,B is now further described. The specific signatures from a captured object are generated using the same algorithms and process as if the object were registered with registration module 1202. This assures that identical signatures will be created for identical textual content on both the registration and capture portions of the system. Search engine 1210A,B receives the list of object signatures from signature generator 1208A,B and initiates a search into local signature database 1216A,B for each signature. Any signatures that are present in both the object and the local signature database are sent, along with the corresponding document identifier, to notification module 1212A,B. In one embodiment, search engine 1210A,B searches the entire signature list provided by signature generator 1208A,B to completion. In another embodiment, search engine 1210A,B stops searching operations after a specific number (such as 10) of matched signatures have been found. This allows faster system operation if that specific number of hits is considered indicative of a strong overall document match.

The notification module 1212A,B receives a list of matching signatures from search engine 1210A,B and determines if a notification should be sent to registration module 1202 of the manager agent 1200. This determination may be based on a number of factors including the number of signatures that were matched, the number of different documents the matched signatures originated from, the number of signatures relative to the overall size of the captured object, other factors as determined by the system configuration, or a combination of any of the above factors. Additional factors that may be used include the time of day the object was captured (after hours versus middle of day), the type of object (standard email message versus a file transfer), or any intrinsic property of the captured object.

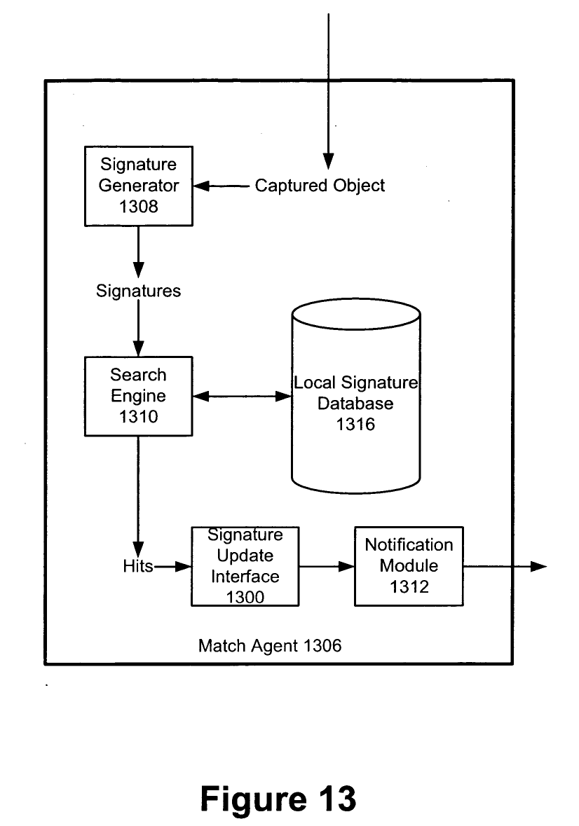

FIG. 13 illustrates an embodiment of a match agent to provide signature match processing. The match agent 1300 generates a list of signature matches between a captured object and registered documents that have signatures in the local signature database 1316.

The signature generator 1308 generates signatures for objects that the match agent 1300 has captured. The match agent 1300 may include object capture modules and network interface modules (not shown) to aid in capturing objects. This signature generator 1308 operates in a manner as described earlier with respect earlier signature generators including generating signatures from tokens of extracted/decoded content. These signatures are passed to a search engine 1310 for further processing.

The search engine 1310 (similar or identical to search engine 710 in FIG. 7) compares the signature(s) of the captured object from the signature generator 1308 with signatures stored in the local signature database 1316. The search engine 1310 creates a list of matches found between signatures of the registered content of the local signature database 1316 and the signatures generated by the signature generator 1308. These matches or “hits” may indicate that an attempt to transmit registered content has been made. Lists may also include information based on the text searched. In an embodiment, the search engine 1310 does not create the list and only passes these hits on to a signature update interface 1302 to produce the list. Of course, other techniques aside for creating lists for noting hits may be utilized.

There are several different ways to implement a list of hits. In an embodiment, the list contains only the signatures that match (hit). In this list, if a signature hits twice, the signature is listed twice in the list (see, for example, Table 4 below).

An exemplary hit list without a counter for a captured object is shown below in Table 4:

TABLE 4
Signatures

Signature A
Signature B
Signature A
Signature C
Signature D
Signature E

In this example, five signatures match at least one document that is registered with the local signature database 1316. Signature A has hit twice, which may indicate that this object is more likely to contain information that should not be shared.

In another embodiment, the list contains the signatures that hit and a counter associated with each signature. This may be advantageous to keep the list size smaller, but adds a level of complexity for keeping track of the counters. An example of this list is shown in Table 5.

TABLE 5

| Hits | Signatures |
|---|---|
| 2 | Signature A |
| 1 | Signature B |
| 1 | Signature C |
| 1 | Signature D |
| 1 | Signature E |

In another embodiment, the list contains all of the signatures stored in the database 1216 and has counter associated with each hit. An example of this list is shown in Table 6.

TABLE 6

| Hits | Signatures |
|---|---|
| 2 | Signature A |
| 1 | Signature B |
| 1 | Signature C |
| 1 | Signature D |
| 1 | Signature E |
| 0 | Signature F |

Associated with at least some of these types of lists is an identifier of the total number hits that an object has with the signature database 1216. For example, this identifier may be a counter than increases by one each time a unique signature hits in the database 1216 or increases by one each time any signature hits regardless if it is an unique hit.

Lists may also contain the document ID associated with the signature that hit. The local signature database may only have a signature associated with one document ID (such as shown in Table 3) or, if a multiple documents have the same signature, identical signatures associated with different document IDs. Table 7 is an example of a list with document IDs attached. Of course it should be understood that the addition of document IDs may be made with respect to any of the lists described above.

TABLE 7

| Hits | Signatures | Document ID |
|---|---|---|
| 2 | Signature A | Document X |
| 1 | Signature B | Document X |
| 1 | Signature C | Document X |
| 1 | Signature D | Document Y |
| 1 | Signature E | Document Y |

In an embodiment, the list is not generated and/or updated for each signature hit. This limits the size and number of lists that are generated. A minimum number of hits is required before the list generation and/or updates. Because certain document types are more likely to have false positives, lists could get extremely long and almost unworkable (require a lot of processing time) very quickly. For example, in certain source code files one-hundred (100) hits may not be considered good enough to generate and/or update a list. If the signature that continually hits is standard header or copyright information it would not be good to list a hit each time. However, if the hits are concentrated on programming comments then it would be good to record in this list for each match.

List size and/or number list may also be reduced by comparing the number of hits to the number of signatures in the database. For example, if only 100 out of 50,000 signatures hit this may be an indication that the document does not contain confidential information.

Another technique to reduce the list size is to discard hits after a certain number of hits have occurred. For example, the first ten hits may be saved and then the rest discarded.

Yet another technique to reduce the list size is to search for patterns such looking at words that surround a signature, looking for signatures in close proximity to each other, etc. For example, if Signature A contains information about social security numbers, Signature B contains credit card information, and they are in close proximity, the likelihood that they are related to confidential information is increased.

Of course other techniques may be utilized to help with hit and/or list reduction.

The local signature database 1316 has the same or similar structure as the master signature database. Generally, in this database 1316 each signature is only stored once. In other words each signature is unique (none are repeated). However, the database, in an embodiment, is a copy of the entire master signature database.

The notification module 1312 forwards lists that it receives from either the search engine 1310 or signature update interface 1302 to the capture/registration system. Exemplary capture/registration systems have been described earlier such as capture/registration system 1200. The notification module 1312 may also record the match in a log file or database (not shown).

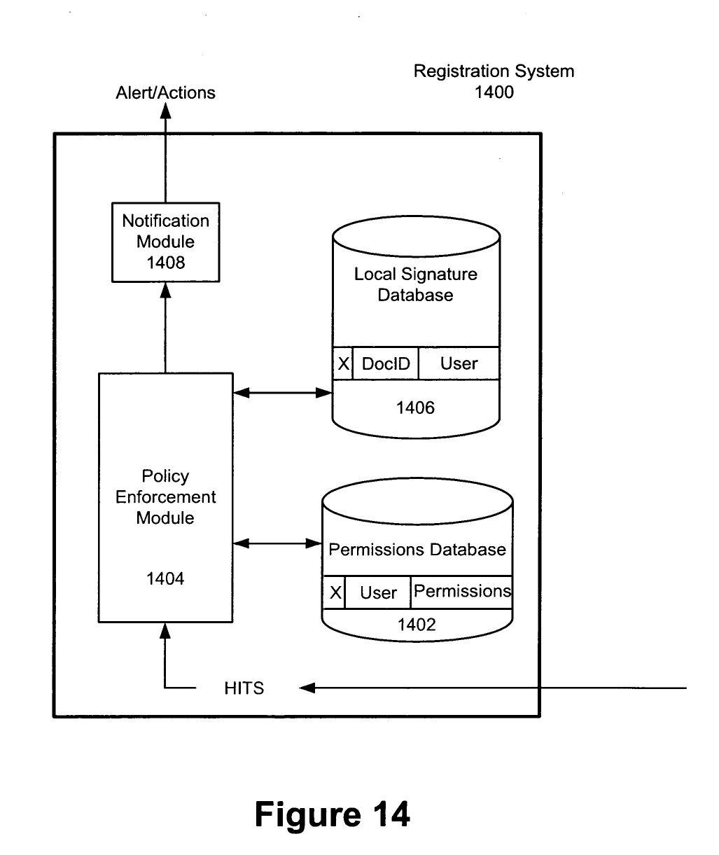

FIG. 14 illustrates an embodiment of a capture/registration system to enforce registered policies with respect to registered documents. The capture/registration system 1400 includes a policy enforcement module 1404, permissions database 1402, and signature database 1406. The capture/registration system 1400 may also be referred to as a registration agent.

The policy enforcement module 1404 receives hit lists from match agents. The policy enforcement module 1404 determines the user associated with a document ID and then determines the permissions associated with that user. These lists may include the number of hits per signature, the signature that hit, the search string used, and/or the document ID associated with the signature that hit. If the list includes the document ID, the policy enforcement module 1404 queries the master signature database 1406 for the user or owner that is associated with the document ID. An exemplary configuration of this type in a signature database 1406 is shown in Table 8.

TABLE 8

| Document ID | User or Owner |
|---|---|
| C source | Programmer_1 |
| Credit card numbers | CFO |
| Java source | Programmer_2 |
| Employee directory | Human Resources |

If the list does not include the document ID, the policy en the policy enforcement module 1404 queries the master signature database 1406 for the user document ID and/or user that is associated with the signature. An exemplary configuration of this type in a signature database 1406 is shown in Table 9.

TABLE 9

| Signature | Document ID | User or Owner |
|---|---|---|
| Signature A | C source | Programmer_1 |
| Signature B | Credit card numbers | CFO |
| Signature C | Java source | Programmer_2 |
| Signature D | Employee directory | Human Resources |

The policy enforcement module 1404 also queries the permissions database 1402 for the permissions associated with a user. A set of permissions is a policy. The permissions database 1402 stores permissions according to user or owner. Table 10 is an example of a permissions database 1402 configuration.

TABLE 10

| User or Owner | Permissions |
|---|---|
| Programmer_1 | Cannot email document |
| CFO | Alert CFO |
| Programmer_2 | Can view and email document |
| Human Resources | Can email document only internally |

In an embodiment, permissions are stored in the master signature database as another entry.

The notification module 1408 sends alerts and/or actions to be taken to registered users and/or owners based on the policy or policies applied.

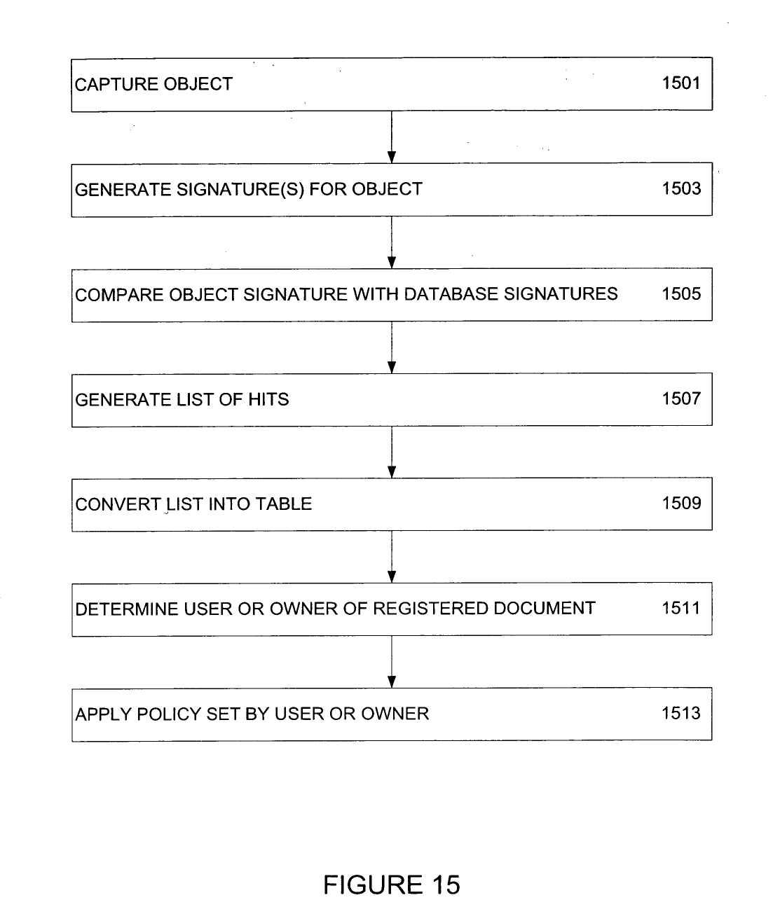

FIG. 15 illustrates an embodiment of the capture and comparison flow. An object is captured at 1501. The capture of an object has been described in detail earlier. The object may be captured in a match agent or in a more generic capture or capture/registration system.

Signatures are generated for the captured object at 1503. Techniques for generating signatures have been described in detail previously. For example, the signature generator 1308 of a match agent 1306 may generate signatures for the captured object.

These signatures generated for the captured object are compared with the signature database at 1505. For example, the search engine 1310 compares the signatures of the captured object and the local signature database 1316. A list of hits is generated from the signature comparison at 1507. This list of hits may be forwarded to a registration system, such as registration system 1400, for further processing.

The list of hits is converted into a table format at 1509. This table may include the number of hits per signature, the signature that hit, the search string used, and/or the document ID associated with the signature that hit. This table may be forwarded to or generated in a registration system, such as registration system 1400, for further processing.

The user or owner of a registered document associated with at least one hit and/or document ID from the table is determined at 1511. The master signature database 1406 may contain information relating a document ID to a user or owner.

The policy set by the user or owner is applied at 1513. Exemplary policies include, but are not limited to, notifying the user or owner, denying the transaction, allowing the transaction, changing the registration of the document, and logging the occurrence.

While the above flow has been predominately been described with respect to the use of a match agent and registration system, the principles are applicable to other capture and capture/registration systems.

### Closing Comments

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

In one embodiment, a capture system is an appliance constructed using commonly available computing equipment and storage systems capable of supporting the software requirements.

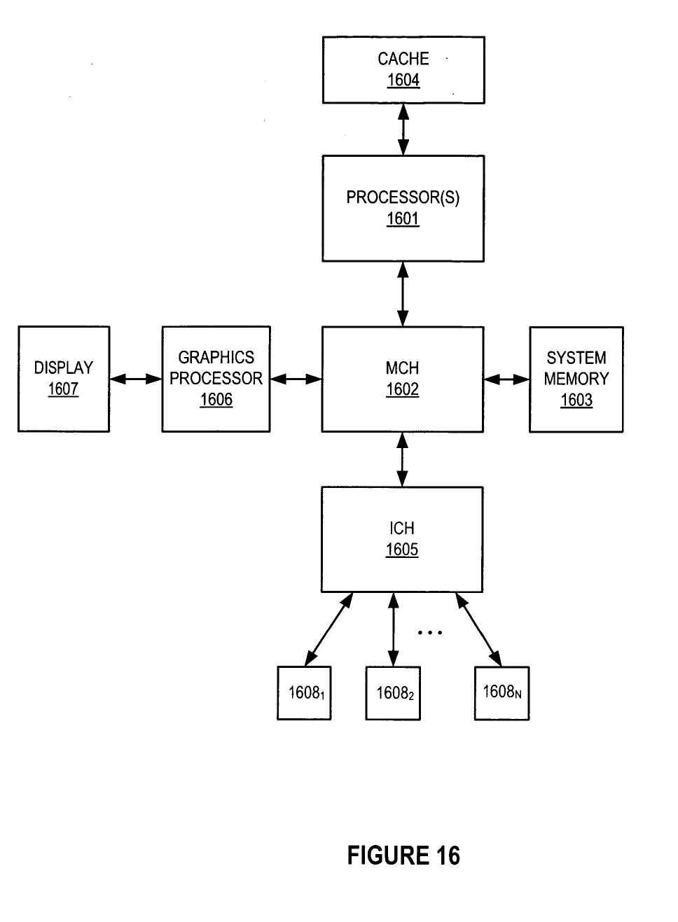

FIG. 16 shows an embodiment of a computing system (e.g., a computer). The exemplary computing system of FIG. 16 includes: 1) one or more processors 1601; 2) a memory control hub (MCH) 1602; 3) a system memory 1603 (of which different types exist such as DDR RAM, EDO RAM, etc,); 4) a cache 1604; 5) an I/O control hub (ICH) 1605; 6) a graphics processor 1606; 7) a display/screen 1607 (of which different types exist such as Cathode Ray Tube (CRT), Thin Film Transistor (TFT), Liquid Crystal Display (LCD), Digital Light Processing (DLP), Organic LED (OLED), etc.; and 8) one or more I/O and storage devices 1608.

The one or more processors 1601 execute instructions in order to perform whatever software routines the computing system implements. The instructions frequently involve some sort of operation performed upon data. Both data and instructions are stored in system memory 1603 and cache 1604. Cache 1504 is typically designed to have shorter latency times than system memory 1603. For example, cache 1604 might be integrated onto the same silicon chip(s) as the processor(s) and/or constructed with faster SRAM cells whilst system memory 1603 might be constructed with slower DRAM cells. By tending to store more frequently used instructions and data in the cache 1604 as opposed to the system memory 1603, the overall performance efficiency of the computing system improves.

System memory 1603 is deliberately made available to other components within the computing system. For example, the data received from various interfaces to the computing system (e.g., keyboard and mouse, printer port, LAN port, modem port, etc.) or retrieved from an internal storage element of the computing system (e.g., hard disk drive) are often temporarily queued into system memory 1603 prior to their being operated upon by the one or more processor(s) 1601 in the implementation of a software program. Similarly, data that a software program determines should be sent from the computing system to an outside entity through one of the computing system interfaces, or stored into an internal storage element, is often temporarily queued in system memory 1603 prior to its being transmitted or stored.

The ICH 1605 is responsible for ensuring that such data is properly passed between the system memory 1603 and its appropriate corresponding computing system interface (and internal storage device if the computing system is so designed). The MCH 1602 is responsible for managing the various contending requests for system memory 1603 access amongst the processor(s) 1601, interfaces and internal storage elements that may proximately arise in time with respect to one another.

One or more I/O devices 1608 are also implemented in a typical computing system. I/O devices generally are responsible for transferring data to and/or from the computing system (e.g., a networking adapter); or, for large scale non-volatile storage within the computing system (e.g., hard disk drive). ICH 1605 has bi-directional point-to-point links between itself and the observed I/O devices 1608. A capture program, classification program, a database, a filestore, an analysis engine and/or a graphical user interface may be stored in a storage device or devices 1608 or in memory 1603.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

Thus, a capture system and a document/content registration system have been described. In the forgoing description, various specific values were given names, such as “objects,” and various specific modules, such as the “registration module” and “signature database” have been described. However, these names are merely to describe and illustrate various aspects of the present invention, and in no way limit the scope of the present invention. Furthermore, various modules, may be implemented as software or hardware modules, combined or without dividing their functionalities into modules at all. The present invention is not limited to any modular architecture either in software or in hardware, whether described above or not.

What is claimed is:

1. A method comprising:
receiving an object being transmitted over a network at a distributed match agent of a document registration system;
generating a set of signatures associated with the object;
comparing the set of signatures associated with the object to signatures associated with at least one document registered with the document registration system;
generating a list of signature matches as a result of the comparing;
determining ownership of the at least one document; and
applying a policy set by the owner of the at least one document.

2. The method of claim 1, wherein the generating a list of signature matches comprises:
creating a table, the table including at least one relationship between a signature and a registered document identifier.

3. The method of claim 1, wherein the applying a policy set by the owner of the at least one document comprises:
determining whether to notify the owner of the at least one document of the signature match.

4. The method of claim 3, further comprising:
sending a notification to the owner of the at least one document, the notification indicating the presence of registered content in the object.

5. The method of claim 3, wherein the determining whether to notify the owner comprises:
comparing the number of signatures from the set of signatures that were matched to a threshold number.

6. The method of claim 1, wherein the set of signatures generated for the object and the at least one register document are generated using the same signature generation procedure.

7. The method of claim 1, wherein the applying a policy set by the owner of the at least one document comprises:
logging the match between signatures.

8. The method of claim 1, wherein the generating the list is halted after a pre-determined number of signature matches.

9. The method of claim 1, wherein the determining ownership of the at least one document is performed by a registration agent.

10. The method of claim 1, further comprising:
forwarding the list of signature matches from the distributed match agent to a registration agent.

11. The method of claim 10, wherein the forwarding is performed if the number of matches in the list is above a threshold level.

12. A document registration system comprising:
a manager agent including:
a master signature database to maintain document identifiers associated with a user of the document registration system,
a permissions database to maintain at least one permission associate with a user of the document registration system, and
a policy enforcement module to apply the at least one permission from the permissions database; and
a match agent including:
at least one object capture module to capture an object being transmitted over a network,
a signature generator to generate a set of signatures associated with the object,
a search engine to compare the set of signatures associated with the object with signatures stored in a local signature database of the distributed match agent that are associated with registered documents and to generate a list of matches, and
a notification module to determine whether to send a notification to the manager agent of registration system based on the result of the comparison.

13. The document registration system of claim 12, wherein the local signature database is periodically updated by the manager agent.

14. The document registration system of claim 12, wherein the notification indicates content of a registered document in the object.

15. The document registration system of claim 12, wherein the set of signatures generated for the intercepted object and the registered documents are generated using the same signature generation procedure.

16. The document registration system of claim 12, wherein the list is created if the number of matches is above a threshold level.

17. The document registration system of claim 12, wherein the registration agent is notified if the list contains number of matches above a threshold level.

18. An article of manufacture including program code which, when executed by a machine, causes the machine to perform a method, the method comprising:
receiving an object being transmitted over a network at a distributed match agent of a document registration system;
generating a set of signatures associated with the object;
comparing the set of signatures associated with the object to signatures associated with at least one document registered with the document registration system;
generating a list of signature matches as a result of the comparing;
determining ownership of the at least one document; and
applying a policy set by the owner of the at least one document.

19. The article of manufacture of claim 18, wherein the generating a list of signature matches comprises:
creating a table, the table including at least one relationship between a signature and a registered document identifier.

20. The article of manufacture of claim 18, wherein the applying a policy set by the owner of the at least one document comprises:
determining whether to notify the owner of the at least one document of the signature match.

21. The article of manufacture of claim 20, further comprising:
sending a notification to the owner of the at least one document, the notification indicating the presence of registered content in the object.

22. The article of manufacture of claim 20, wherein the determining whether to notify the owner comprises:
comparing the number of signatures from the set of signatures that were matched to a threshold number.

23. The article of manufacture of claim 18, wherein the set of signatures generated for the object and the at least one register document are generated using the same signature generation procedure.

24. The article of manufacture of claim 18, wherein the applying a policy set by the owner of the at least one document comprises:
logging the match between signatures.

25. The article of manufacture of claim 18, wherein the generating the list is halted after a pre-determined number of signature matches.

26. The article of manufacture of claim 18, wherein the determining ownership of the at least one document is performed by a registration agent.

27. The article of manufacture of claim 18, further comprising:
forwarding the list of signature matches from the distributed match agent to a registration agent.

28. The article of manufacture of claim 27, wherein the forwarding is performed if the number of matches in the list is above a threshold level.
